(19) United States
(12) Patent Application Publication
(10) Pub. No.: US 2012/0240626 A1
(43) Pub. Date: Sep. 27, 2012

(54) PROCESS FOR PRODUCING CHEMICALLY STRENGTHENED GLASS SUBSTRATE FOR DISPLAY DEVICE

(75) Inventors: Syuji MATSUMOTO, Tokyo (JP); Tsuguhide Isemura, Tokyo (JP); Koji Nakagawa, Tokyo (JP); Kazutaka Ono, Tokyo (JP); Shusaku Akiba, Tokyo (JP); Haruo Aizawa, Tokyo (JP)

(73) Assignee: Asahi Glass Company, Limited, Tokyo (JP)

(21) Appl. No.: 13/428,629

(22) Filed: Mar. 23, 2012

(30) Foreign Application Priority Data
Mar. 24, 2011 (JP) 2011-065381
Jan. 17, 2012 (JP) 2012-007211

(51) Int. Cl. C03C 21/00

(52) U.S. Cl. 65/30.14

(57) ABSTRACT

The present invention relates to a process for producing a chemically strengthened glass substrate for a display device, the process including a pre-heating step of pre-heating a glass to a pre-heating temperature and subsequently an ion exchange step of immersing the glass in a chemical strengthening liquid, in which the pre-heating temperature in the pre-heating step and a strain point of the glass satisfy: 220° C.≦(strain point−pre-heating temperature).

### FIELD OF THE INVENTION

The present invention relates to a process for producing a chemically strengthened glass substrate for a display device.

### BACKGROUND OF THE INVENTION

A glass chemically strengthened by ion exchange or the like (hereinafter referred to as a “chemically strengthened glass”) has been used in a cover glass of display devices such as a digital camera, a mobile phone and PDA, and a glass substrate of touch panel displays. Such a chemically strengthened glass has high mechanical strength as compared with an unstrengthened glass, and is therefore suitable for those uses (see JP-A-57-205343, JP-A-9-236792 and JP-A-2009-84076).

A cover glass of display devices and the like, and a glass substrate of touch panel displays are required to have high transparency, high smoothness and good appearance.

A glass obtained by chemically strengthening a soda-lime glass has been widely used as a cover glass of display devices and the like, and a glass substrate of touch panel displays (see JP-A-2007-11210). Although such a soda-lime glass is inexpensive and has a characteristic that a compressive stress layer formed on a glass surface by chemical strengthening can be provided with a surface compressive stress of 200 MPa or more, there has been a problem that it is not easy to control the thickness of the compressive stress layer to be 30 μm or more.

In view of the above, a glass obtained by chemically strengthening an SiO₂—Al₂O₃—Na₂O glass different from the soda-lime glass has been proposed as the cover glass (see US 2008/0286548 and JP-A-2010-275126). The SiO₂—Al₂O₃—Na₂O glass disclosed in these documents has a characteristics that the surface compressive stress can be controlled to 200 MPa or more, and additionally, a thickness of the compressive stress layer can be controlled to 30 μm or more.

However, in the case of using a chemically strengthened glass in a display device, there was a case that the problem occurs in appearance.

### SUMMARY OF THE INVENTION

The present inventors have made an analysis on a glass substrate in which a problem occurred in appearance. As a result, it has been found that extremely small dented defects (hereinafter referred to as “dented defects”) occur on a surface of the glass substrate.

Accordingly, the present invention has an object to provide a process for producing a chemically strengthened glass substrate for a display device, which is capable of suppressing occurrence of dented defects.

As a result of further investigations on the above problems by the present inventors, it has been found that when a calcium salt is present on a surface of a glass to be subjected to a chemical strengthening step, calcium is firmly fixed to the surface of the glass by passing the glass through a drying step, and due to the calcium firmly fixed, dented defects occur by passing the glass through a chemical strengthening step.

It has been further found that when temperature conditions in a pre-heating step before the chemical strengthening step are appropriately controlled, the dented defects in the glass can effectively be suppressed even by passing the glass through the chemical strengthening step. The present invention has been completed based on the above findings.

Namely, the present invention provides the following items 1 to 8.

1. A process for producing a chemically strengthened glass substrate for a display device, the process comprising a pre-heating step of pre-heating a glass to a pre-heating temperature and subsequently an ion exchange step of immersing the glass in a chemical strengthening liquid,

wherein the pre-heating temperature in the pre-heating step and a strain point of the glass satisfy the following formula:

220° C.≦(strain point−pre-heating temperature).

2. The process for producing a chemically strengthened glass substrate for a display device according to item 1 above, wherein the value of (strain point−pre-heating temperature) is 280° C. or less.

3. The process for producing a chemically strengthened glass substrate for a display device according to item 1 or 2 above, wherein a chemical strengthening liquid temperature in the ion exchange step and the strain point of the glass satisfy the following formula:

120° C.≦(strain point−chemical strengthening liquid temperature).

4. The process for producing a chemically strengthened glass substrate for a display device according to item 3 above, wherein the value of (strain point−chemical strengthening liquid temperature) is 170° C. or less.

5. The process for producing a chemically strengthened glass substrate for a display device according to any one of items 1 to 4 above, wherein the pre-heating temperature in the pre-heating step and a chemical strengthening liquid temperature in the ion exchange step satisfy the following formula:

55° C.≦(chemical strengthening liquid temperature−pre-heating temperature).

6. A process for producing a chemically strengthened glass substrate for a display device, the process comprising a pre-heating step of pre-heating a glass to a pre-heating temperature and subsequently an ion exchange step of immersing the glass in a chemical strengthening liquid,

wherein a chemical strengthening liquid temperature in the ion exchange step and a strain point of the glass satisfy the following formula:

150° C.≦(strain point−chemical strengthening liquid temperature), and

wherein a time for immersing the glass in the chemical strengthening liquid is 12 hours or more.

7. The process for producing a chemically strengthened glass substrate for a display device according to any one of items 1 to 6 above, wherein a compressive stress layer formed on a surface of the chemically strengthened glass substrate has a surface compressive stress of 200 MPa or more.

8. The process for producing a chemically strengthened glass substrate for a display device according to any one of items 1 to 7 above, wherein a compressive stress layer formed on a surface of the chemically strengthened glass substrate has a thickness of 30 μm or more.

According to the production process of the present invention, a thickness of a layer containing calcium ions diffused therein from calcium salts present as impurities on a surface of a glass can sufficiently be decreased by controlling a pre-heating temperature of a glass in a pre-heating step. Accordingly, occurrence of dented defects, which may occur due to the prevention of ion exchange in the ion exchange step by the calcium ion layer, can be prevented and depths of dented defects can be decreased, whereby the appearance of the glass substrate can be improved.

Furthermore, according to the production process of the present invention, as a preferred embodiment, the occurrence of dented defects can further effectively be suppressed by controlling a pre-heating temperature of a glass in a pre-heating step and additionally controlling a temperature of a chemical treatment liquid in a chemical strengthening step, whereby depths of dented defects can be decreased.

### BRIEF DESCRIPTION OF THE DRAWINGS

FIG. 1 is a view showing mechanism of occurrence of dented defects in a production process of a chemically strengthened glass.

FIG. 2 is a graph showing the correlation between a depth of dented defects and a calcium concentration in a solution to be contacted with a glass before a pre-heating step.

FIG. 3 is a flow chart showing an analysis method of dented defects occurred on a glass surface by conducting pre-heating and ion exchange treatment after adding dropwise a solution containing calcium.

FIG. 4 is a view showing the result of a texture image of a dented defect occurred on a glass surface by conducting pre-heating and ion exchange treatment after adding dropwise a solution containing calcium.

FIG. 5 is a view showing a depth and a width of a dented defect occurred on a glass surface by conducting pre-heating and ion exchange treatment after adding dropwise a solution containing calcium.

FIG. 6 is a view showing the result of a texture image of a dented defect occurred on a glass surface by conducting pre-heating and ion exchange treatment after adding dropwise a solution containing calcium.

FIG. 7 is a view showing a depth and a width of a dented defect occurred on a glass surface by conducting pre-heating and ion exchange treatment after adding dropwise a solution containing calcium.

FIGS. 8A to 8C are views showing the correlation between a depth of a calcium diffusion layer and a pre-heating temperature, in which FIG. 8A shows a case where a pre-heating temperature is 330° C. (value of (strain point−pre-heating temperature) is 248° C.), FIG. 8B shows a case where a pre-heating temperature is 350° C. (value of (strain point−pre-heating temperature) is 228° C.), and FIG. 8C shows a case where a pre-heating temperature is 400° C. (value of (strain point−pre-heating temperature) is 178° C.).

FIG. 9 is a view showing the correlation between depths of dented defects and a pre-heating temperature.

FIG. 10 is a view (magnification: 150) showing content distribution of K₂O, Na₂O and CaO in a glass on a surface of a dented defect occurred on a glass surface by conducting pre-heating and ion exchange treatment after adding dropwise a solution containing calcium.

### DETAILED DESCRIPTION OF THE INVENTION

The present invention is described in detail below, but the invention is not construed as being limited thereto.

A process for producing a chemically strengthened glass substrate for a display device according to the present invention generally includes sequentially a polishing step of polishing a glass, a cleaning step, a final cleaning step, a drying step, and a chemical strengthening step. The chemical strengthening step includes an ion exchange step as an essential step, and in many cases, further includes a pre-heating step before the ion exchange step.

### Mechanism of Occurrence of Dented Defects

The present inventors have found that deterioration of appearance of a chemically strengthened glass substrate is due to dented defects, and have found that the dented defects in the chemically strengthened glass substrate are due to a calcium salt present on a glass surface before the pre-heating step.

Causes that the calcium salt adheres to a glass surface include (a) incorporation of calcium in abrasives used in a polishing step, (b) incorporation of calcium in a cleaning liquid used in a cleaning step or a final cleaning step, and (c) adhesion of calcium contained in sweat of human or incorporation of the calcium in a cleaning liquid, due to touching a glass with bare hands in a manufacturing process.

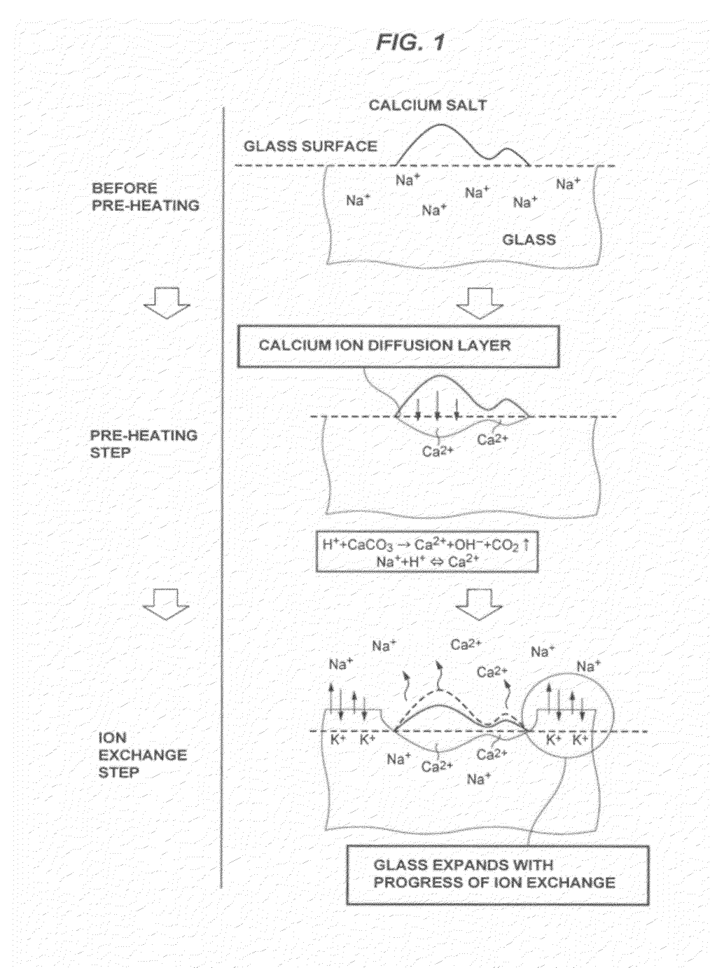

The mechanism of occurrence of dented defects in a manufacturing process of a chemically strengthened glass substrate, found by the present inventors is as follows (FIG. 1).

FIG. 1 explains as one example, a case where a potassium nitrate molten salt is used as a molten salt used in an ion exchange step.

### (1) Before Pre-Heating Step

Calcium salt adheres to a glass surface before a pre-heating step, and is firmly fixed thereto by passing through a drying step. Examples of the calcium salt include CaCO₃, Ca(NO₃)₂ and CaSO₄.

### (2) Pre-Heating Step

A glass is heated in a pre-heating step, and as a result, calcium ions, which is generated from the calcium salt firmly fixed to a glass surface, incorporate in a glass, and a calcium ion-diffused layer (hereinafter may also be referred as “calcium ion diffusion layer”) is formed. The calcium ion diffusion layer becomes a barrier substance which inhibits ion exchange in the subsequent ion exchange step.

### (3) Ion Exchange Step

It is considered that even in the ion exchange step, the glass is heated by immersing the glass in a chemical strengthening liquid heated; calcium ions, which are generated from the calcium salt firmly fixed to the glass surface, further incorporate in the glass; and a depth of the calcium ion diffusion layer is further increased. In the ion exchange step, sodium ions contained in the glass are substituted with potassium ions contained in the molten salt and having an ion radius larger than that of the sodium ions, whereby the glass expands. On the other hand, in sites at which a barrier substance due to the calcium ion diffusion layer is formed, since the calcium ions inhibit ion exchange, the calcium ion diffusion layer becomes a barrier film to ion exchange, so that the glass does not expand, depressions occur, and the depressions become defects.

### Correlation Between Calcium Concentration and Dented Defects

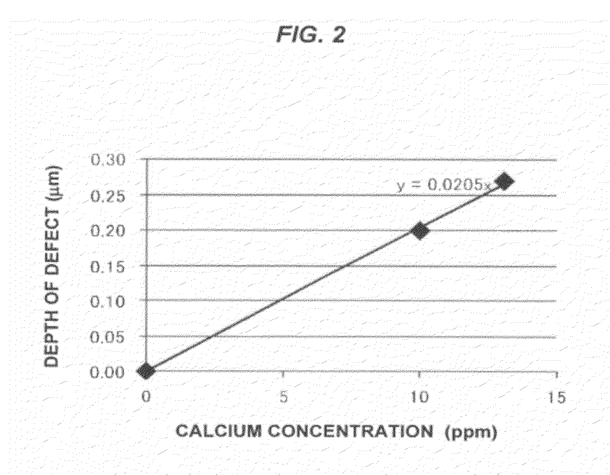

As a result of analyzing the correlation between depths of dented defects and a calcium concentration in the solution to be contacted with a glass before a pre-heating step, the present inventors have found that there is a proportional relationship as shown in FIG. 2. The reasons that the depths of dented defects and the calcium concentration in the solution to be contacted with a glass before a pre-heating step have the proportional relationship are considered to be as follows.

The reason that dented defects occur on a surface of a glass substrate in the chemical strengthening step is that residual calcium on the glass surface becomes a barrier film to ion exchange by the pre-heating step, as described before. A depth that sodium ions and potassium ions are exchanged is typically from several ten to several hundred μm. On the other hand, assuming that water droplets having a calcium concentration of about 10 ppm have a diameter of, for example, 5 mm, a thickness of a calcium barrier film after evaporation of water does not reach 1 nm.

Therefore, the thickness of the barrier film is sufficiently small with respect to a path that potassium ions and sodium ions actually move. As a result, it can be considered that physical parameters relating to diffusion of ions are unchanged, and it is considered that the actual parameters are in proportion to only the thickness of the barrier film which is in proportion to the calcium concentration.

As a result of investigations of the correlation between depth of dented defect in a chemically strengthened glass substrate and appearance of the glass substrate, the present inventors have found that glass substrates having a depth of dented defect exceeding 200 nm substantially impair appearance, but the appearance is not impaired when the depth of the dented defect is nearly 200 nm or less. This is considered because the depth of dented defect that can visually be recognized by general human eyes is about 200 nm or more which is ½ of visible light (about 400 nm or more).

According to the production process of the present invention, by controlling the pre-heating temperature of a glass in the pre-heating step, calcium ions generated from a calcium salt firmly fixed to a glass surface by heating the glass are inhibited from being incorporated in the glass, thereby preventing formation of a calcium ion diffusion layer. As a result, occurrence of dented defect can be suppressed, and additionally, the depth of dented defect can be suppressed to 200 nm or less.

In the production process of the present invention, a chemically strengthened glass can be manufactured by conventional methods, except that the preheating temperature is controlled in the pre-heating step.

### Process for Producing Glass Before Chemical Strengthening

A glass to be subjected to chemical strengthening in the production process of the present invention can be manufactured by introducing desired glass raw materials in a continuous melting furnace, melting the glass raw materials at preferably from 1,500 to 1,600° C., refining the molten glass, feeding the molten glass to a molding apparatus, molding the molten glass into a sheet shape, and annealing the resulting sheet glass.

### Composition of the Glass Manufactured by the Production Process of the Present Invention is not Particularly Limited.

Various methods can be employed in molding a glass substrate. For example, various molding methods such as a downdraw process (for example, overflow downdraw process, slot downdraw process and redraw process), a float process, a roll-out process and a pressing process can be employed.

### Polishing Step

Polishing step is a step of polishing the glass substrate manufactured by the above production process with a polishing pad while supplying a polishing slurry. As the polishing slurry, a polishing slurry containing an abrasive and water may be used. In the production process of the present invention, the polishing step is an optional step employed according need.

The abrasive used is preferably cerium oxide (ceria) and silica. The presence of calcium on the surface of the glass substrate causes dented defects by passing the glass substrate through the pre-heating and ion exchange treatment as described before. Therefore, it is preferred that calcium is not contained in the abrasive.

### Cleaning Step

Cleaning step is a step of cleaning the glass substrate polished by the polishing step with a cleaning liquid. The cleaning liquid is preferably a neutral detergent and water. The glass substrate is more preferably cleaned with water after cleaning with a neutral detergent. As the neutral detergent, commercially available ones can be used.

The presence of calcium on the surface of the glass substrate causes dented defects by passing the glass substrate through the pre-heating and ion exchange treatment as described before. Therefore, it is preferred that calcium is not contained in the cleaning liquid used in the cleaning step.

### Final Cleaning Step

Final cleaning step is a step of cleaning the glass substrate cleaned in the cleaning step with a cleaning liquid. Examples of the cleaning liquid used include water, ethanol and isopropanol. Of those, water is preferably used.

### Drying Step

Drying step is a step of drying the glass substrate cleaned in the final cleaning step. As drying conditions in the drying step, most suitable conditions may be selected with considering the cleaning liquid used in the cleaning step, properties of the glass, and the like. In the production process of the present invention, the drying step is an optional step employed according to need.

Chemical strengthening step includes a pre-heating step before an ion exchange step, and the ion exchange step.

### Pre-Heating Step

Pre-heating step is a step of heating the glass substrate passed through the drying step to a pre-heating temperature previously set. In the present invention, the pre-heating temperature in the pre-heating step and a strain point of a glass to be subjected to the pre-heating step satisfy the following formula:

220° C.≦(strain point−pre-heating temperature).

The term “strain point” herein is a temperature at which viscous fluidity of a glass does not substantially occur, and which corresponds to a lower limit temperature in an annealing region, and means a temperature corresponding to a viscosity of 10^{14.5} dPa·s (poise). The strain point is measured in accordance with fiber elongation method defined in JIS-R3103 (2001) and ASTM-C336 (1971).

The value of (strain point−pre-heating temperature) is 220° C. or more, preferably 230° C. or more, and more preferably 240° C. or more. Where the value of (strain point−pre-heating temperature) is lower than 220° C., calcium ions present as impurities on the glass surface sufficiently deeply incorporate in the glass (50 nm or more), and dented defects having a depth exceeding 200 nm are generated in the glass by passing through the ion exchange treatment, resulting in deterioration of appearance of the glass substrate.

Typically, the value of (strain point−pre-heating temperature) is preferably 280° C. or less. When the value of (strain point−pre-heating temperature) is 280° C. or less, the pre-heating becomes sufficient, temperature difference to the temperature of the ion exchange treatment is not too large, and the glass can be prevented from being broken by heat shock.

As the pre-heating time, optimum conditions may be selected with considering a molten salt (namely, chemical strengthening liquid) and the like used in the ion exchange step. In general, the pre-heating time is preferably from 2 to 6 hours.

### Ion Exchange Step

Ion exchange step is a step of substituting alkali ions (for example, sodium ions) having small ion radius on the surface of the glass with alkali ions (for example, potassium ions) having large radium by immersing the pre-heated glass in a molten salt (chemical strengthening liquid). For example, the ion exchange step can be conducted by, for example, treating a glass containing sodium ions with a molten salt (chemical strengthening liquid).

In the present invention, a temperature of the chemical strengthening liquid in the ion exchange step and a strain point of the glass preferably satisfy the following formula:

120° C.≦(strain point−chemical strengthening liquid temperature).

When the value of (strain point−chemical strengthening liquid temperature) is 120° C. or more, the calcium ions present as impurities on the glass surface can be prevented from being incorporated in the glass, thereby preventing calcium ions incorporated in the glass from causing dented defects.

The value of (strain point−chemical strengthening liquid temperature) is preferably 170° C. or less. When the value of (strain point−chemical strengthening liquid temperature) is 170° C. or less, ion exchange is sufficiently conducted, and the glass can be prevented from being broken by heat shock.

Examples of the molten salt for conducting the ion exchange treatment include a molten salt obtained by melting an alkali nitrate, an alkali sulfate or alkali an chloride, such as sodium nitrate, potassium nitrate, sodium sulfate, potassium sulfate, sodium chloride and potassium chloride. Those molten salts may be used alone or as mixtures of two or more thereof.

In the present invention, time for immersing the glass substrate in the chemical strengthening liquid is preferably 1 hour or more, and more preferably 2 hours or more, in order to impart sufficient compressive stress to the glass substrate. Long-term ion exchange decreases productivity, and additionally decreases compressive stress value due to relaxation. Therefore, the ion exchange time is preferably 12 hours or less.

In the case that the time of immersing the glass in the chemical strengthening liquid is preferably 12 hours or more, and more preferably 18 hours or more, the value of (strain point−chemical strengthening liquid temperature) in the ion exchange step is preferably 150° C. or more, more preferably 160° C. or more, and further preferably 170° C. or more. When the time of immersing the glass in the chemical treating liquid is 12 hours or more, and the value of (strain point−chemical strengthening liquid temperature) is 150° C. or more, diffusion rate of Ca²⁺ ions becomes sufficiently slow, and the effect of preventing mutual diffusion of Na⁺/K⁺ is reduced. As a result, occurrence of dented defects can be suppressed.

In the present invention, the pre-heating temperature in the pre-heating step and the temperature of the chemical strengthening liquid in the ion exchange step preferably satisfy the following formula:

55° C.≦(chemical strengthening liquid temperature−pre-heating temperature).

The value of (chemical strengthening liquid temperature−pre-heating temperature) is preferably 55° C. or more, and more preferably 60° C. or more. When the value of (chemical strengthening liquid temperature−pre-heating temperature) is 55° C. or more, occurrence of dented defects can be suppressed.

The value of (chemical strengthening liquid temperature−pre-heating temperature) is preferably 150° C. or less. When the value of (chemical strengthening liquid temperature−pre-heating temperature) is 150° C. or less, ion exchange becomes sufficient, and the glass can be prevented from being broken by heat shock.

A compressive stress layer formed on the surface of the glass substrate chemically strengthened by the production process of the present invention has a surface compressive stress of preferably 200 MPa or more, and more preferably 300 MPa or more. When the compressive stress layer formed on the surface of the chemically strengthened glass substrate has the surface compressive stress of 200 MPa or more, the glass substrate can be made difficult to break. Typically, the surface compressive stress is preferably less than 1,050 MPa.

The compressive stress layer formed on the surface of the glass substrate chemically strengthened by the production process of the present invention has a thickness of preferably 30 μm or more, more preferably 40 μm or more, and typically, preferably 45 μm or more or 50 μm or more. When the compressive stress layer has a thickness of 30 μm or more, the glass can be made difficult to break.

### EXAMPLES

The present invention is described below by reference to Examples, but the invention is not construed as being limited to those Examples.

### Example 1

### Analysis of Depth of Dented Defects by Various Solutions

As a result of observing a surface of a chemically strengthened glass substrate for a display, having impaired appearance, it was seen that deterioration of appearance is due to the occurrence of dented defect. Furthermore, as a result of measurement of a depth of dented defect, it was seen that the appearance was impaired by the occurrence of dented defect having a depth exceeding 200 nm. It was further seen that the appearance was not impaired when the depth of dented defect is about 100 nm or less. To examine the cause of occurrence of dented defect, a depth of dented defect at a spot where each of various solutions was allowed to drop onto the glass substrate was measured.

20 μl of each of various solutions shown in Table 1 was allowed to drop onto a glass (composition (mol %): 64.5% of SiO₂, 6.0% of Al₂O₃, 12.0% of Na₂O, 4.0% of K₂O, 11.0% of MgO, 0.1% of CaO, and 2.5% of ZrO₂). The glass was dried at 90° C. for 60 minutes, pre-heated at 400° C. for 4 hours, and then subjected to ion exchange treatment at 450° C. for 7 hours using KNO₃ as a molten salt. Thus, a chemically strengthened glass was obtained.

Depth of dented defect in the chemically strengthened glass obtained was measured by three-dimensionally measuring a surface shape of an object by combining an optical microscope and a dual beam interference objective lens CCD camera and vertically scanning the interference image. The results obtained are shown in Table 1.

TABLE 1

| Solution allowed to drop | Depth of dented defect (μm) |
|---|---|
| Ca(NO₃)₂ 100 ppm | 0.7 |
| NaSiO₃ 100 ppm | No defect |
| Tap water (Ca 13 ppm) | 0.3 |
| Ion-exchanged water | No defect |
| NaCl 100 ppm | No defect |
| MgCl₂ 100 ppm | No defect |
| FeCl₃ 100 ppm | <0.01 |
| CeO₂ 100 ppm | No defect |

As shown in Table 1, it was seen that by contacting the solution containing calcium with the glass substrate and further conducting pre-heating and ion exchange treatment, dented defect having a depth exceeding 200 nm occurs, and appearance is impaired.

### Example 2

### Analysis of Dented Defect Occurred by Dropping Solution Containing Calcium, and Glass Surface Composition in the Vicinity Thereof

20 μl of a Ca(NO₃)₂ aqueous solution (100 ppm) was allowed to drop onto a glass substrate having the same composition as used in Example 1, and the glass substrate was subjected to pre-heating and ion exchange treatment under the same conditions as in Example 1. Composition of the glass surface was observed with a scanning electron microscope, and dented defect part was analyzed by energy dispersive X-ray spectroscopy.

Na content was 3% by mass in terms of Na₂O at the outside of the dented defect, while it was 10% by mass at the dented defect part. K content was 20% by mass in terms of K₂O at the outside of the dented defect, while it was 7% by mass at the dented defect part. The contents of Na and K at the dented defect part are close to the contents of Na₂O and K₂O of the glass before ion exchange, respectively. Furthermore, Ca content was 0.18% by mass in terms of CaO at the outside of the dented defect, while it was 0.22% by mass at the dented defect part.

It was seen from the above facts that in the dented defect occurred on the glass having been subjected to pre-heating and ion exchange treatment after contacting the glass with the solution containing calcium, a calcium salt is formed, and ion exchange between Na and Ca is inhibited.

### Example 3

### Analysis of Dented Defect Occurred by Dropping Solution Containing Calcium

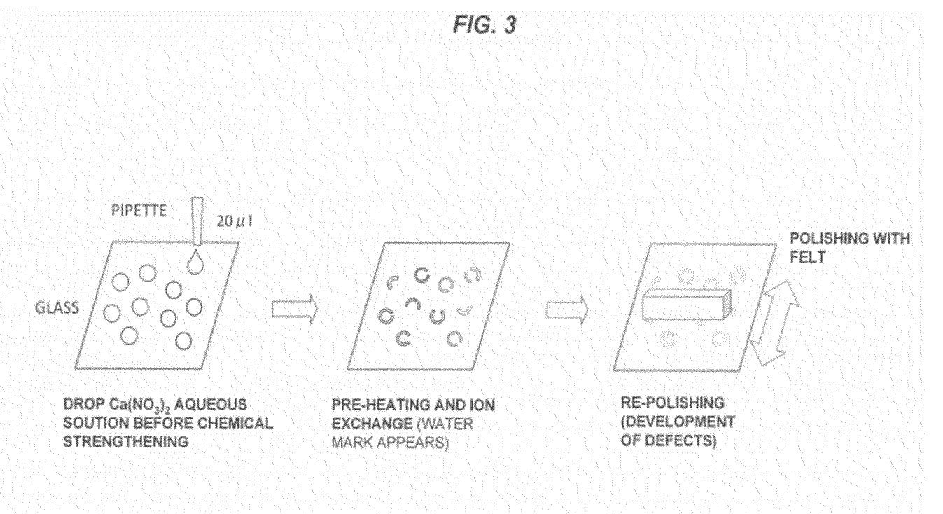

(1) 20 μl of 100 ppm Ca(NO₃)₂ aqueous solution was allowed to drop onto a glass substrate having the same composition as used in Example 1. The glass substrate was subjected to pre-heating and ion exchange treatment under the same conditions as in Example 1, and was re-polished with 3 μm diamond abrasives (FIG. 3). Then, on the glass surface, texture image of dented defect occurred at a site where the Ca(NO₃)₂ aqueous solution had been allowed to drop, and a depth and a width of the dented defect were analyzed.

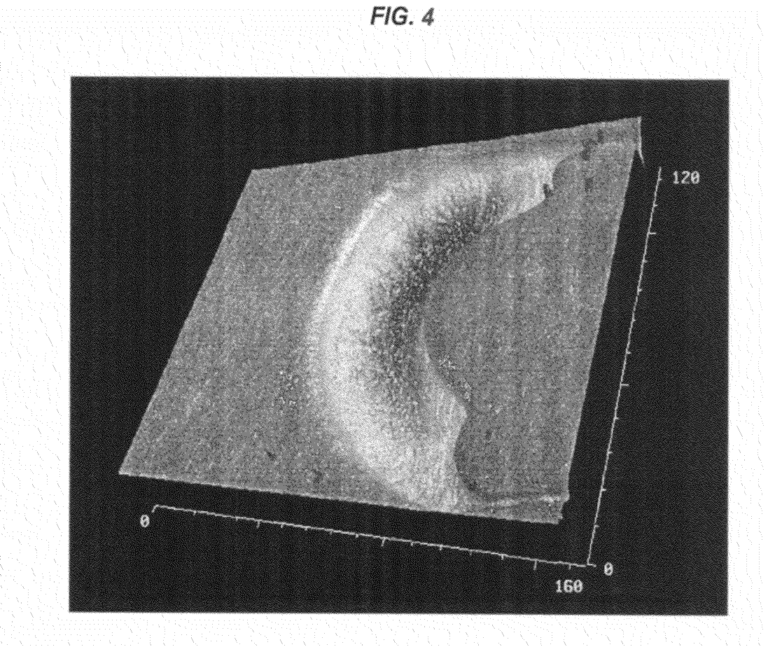

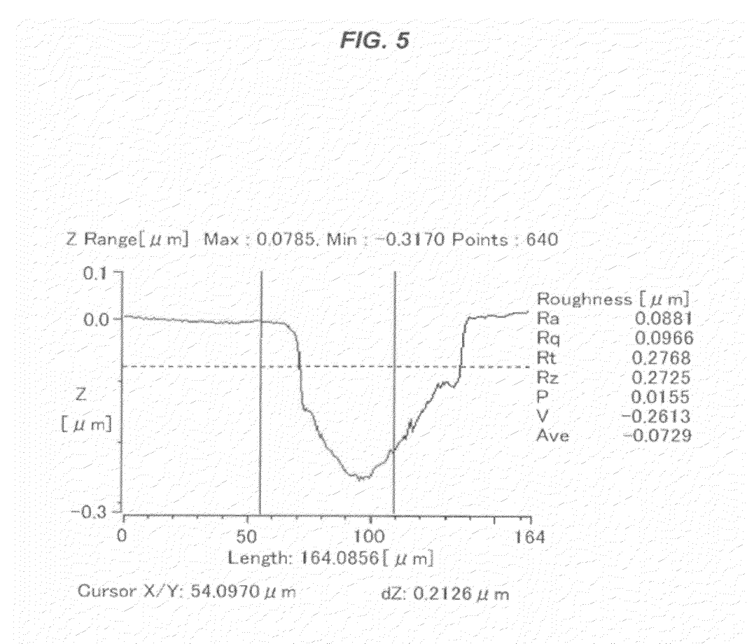

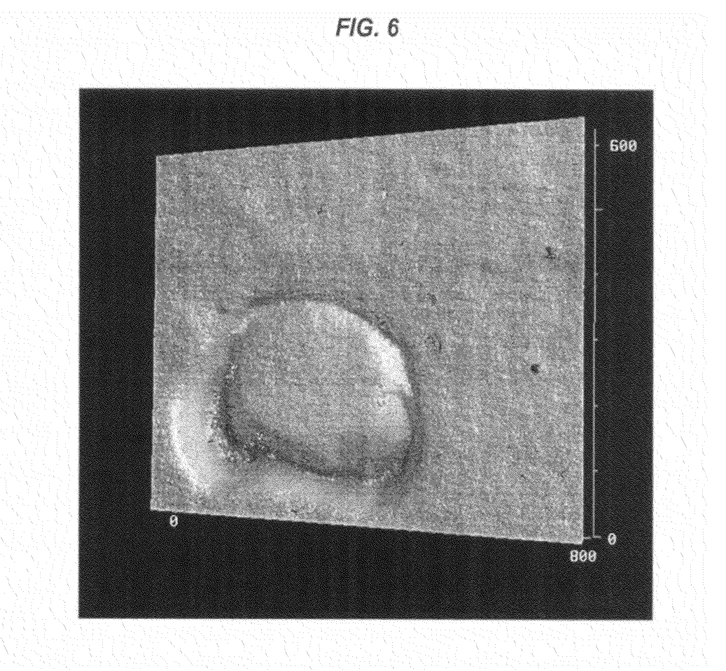

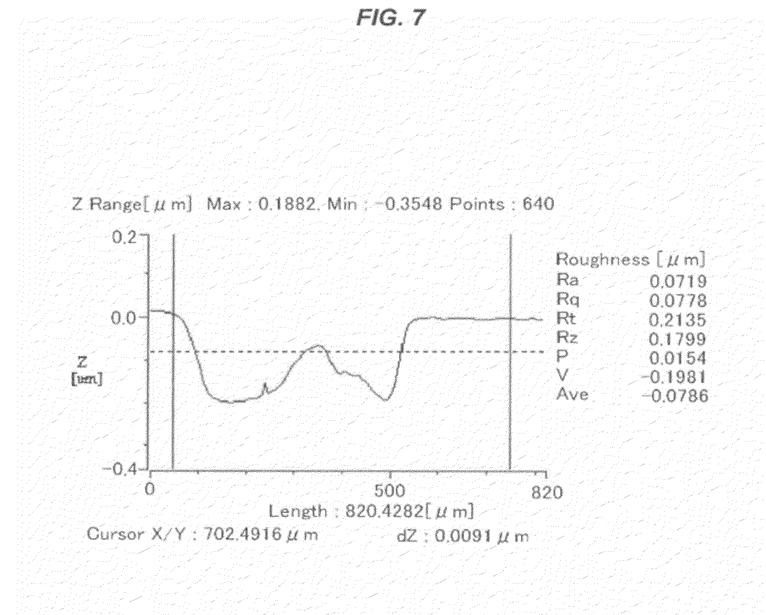

The texture image of the dented defect was analyzed by MM40 manufactured by Ryoka Systems Inc. A depth of the dented defect was measured by three-dimensionally measuring a surface shape of an object by combining an optical microscope and a dual beam interference objective lens CCD camera and vertically scanning the interference image. The result of the texture image of dented defect is shown in FIG. 4, and a depth and a width of dented defect are shown in FIG. 5.
(2) 20 μl of an aqueous solution containing 100 ppm of Ca(NO₃)₂ was allowed to drop onto a glass substrate having the same composition as used in Example 1. The glass substrate was subjected to pre-heating and ion exchange treatment under the same conditions as in Example 1, and was further subjected to ultrasonic cleaning for 5 minutes. On the glass surface, an image of the dented defect occurred at a site where the Ca(NO₃)₂ aqueous solution had been allowed to drop, and a depth and a width of the dented defect were analyzed in the same manner as in (1). The result of the texture image of the dented defect is shown in FIG. 6, and a depth and a width of the dented defect are shown in FIG. 7.

As shown in FIGS. 4 to 7, dented defect occurred on the glass surface to which a solution containing calcium had been allowed to drop. It was seen from the result that dented defect occurs by passing the glass through a pre-heating step and an ion exchange step after contacting the solution containing calcium with the glass surface. Ca content in the glass composition at the dented defect is larger than that at other parts.

### Example 4

### Correlation Between Depth of Calcium Diffusion Layer and Pre-Heating Temperature

A glass substrate having the same composition as used in Example 1 was immersed in a 10,000 ppm Ca(NO₃)₂ aqueous solution for 1 hour, and the glass substrate was then subjected to heat treatment at 330° C., 350° C., 400° C. or 450° C. for 4 hours to simulate a pre-heating step.

Strain point of the glass substrate was measured by glass strain point/annealing point automatic measuring apparatus manufactured by Opto Kikaku. As a result, the strain point was 578° C. Furthermore, Tg (glass transition point) of the glass substrate was measured. As a result, the Tg was 620° C.

A sample obtained by heat treatment was cleaned with warm water, cleaned with ion-exchanged water, and then dried by a dryer at about40° C. for about 12 hours. The dried sample was subjected to a depth direction analysis with X-ray photoelectron spectroscopy, and photoelectron signals of Ca2s and Na2s of the glass substrate in a depth direction from the surface were obtained at an interval of from 1 to 3 nm.

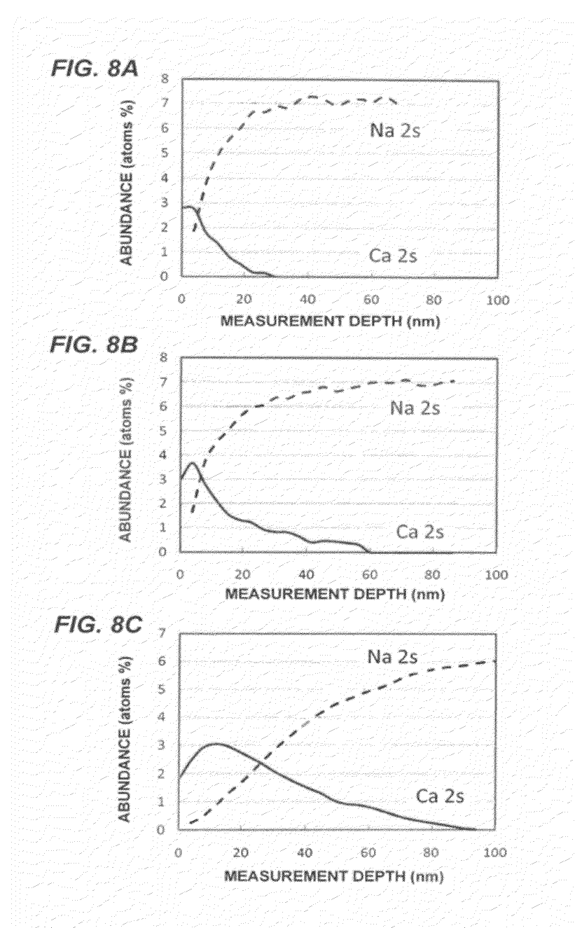

The relationships between photoelectron signal intensity of Ca2s and Na2s of the glass substrate heat-treated at 330° C., 350° C. or 400° C. and a depth from a glass surface are shown in FIGS. 8A to 8C. FIG. 8A shows a case where a pre-heating temperature is 330° C. (value of (strain point−pre-heating temperature) is 248° C.), FIG. 8B shows a case where a pre-heating temperature is 350° C. (value of (strain point−pre-heating temperature) is 228° C.), and FIG. 8C shows a case where a pre-heating temperature is 400° C. (value of (strain point−pre-heating temperature) is 178° C.). The sample heat-treated at 450° C. had rough surface, and it was difficult to correctly conduct measurement by X-ray photoelectron spectroscopy.

As shown in FIGS. 8A to 8C, it was seen that on the extreme surface of the glass, calcium ions diffuse in the glass while conducting ion exchange between calcium ions and sodium ions. To the maximum Ca amount in the glass surface layer, a depth of a calcium ion layer in which detection sensitivity of photoelectron is 1/10 or less is 22 nm at the pre-heating temperature of 330° C. (value of (strain point−pre-heating temperature) is 248° C.), 56 nm at the pre-heating temperature of 350° C. (value of (strain point−pre-heating temperature) is 228° C.), and 79 nm at the pre-heating temperature of 400° C. (value of (strain point−pre-heating temperature) is 178° C.).

It was seen from the results that the depth of the calcium ion diffusion layer is increased with decreasing the value of (strain point−pre-heating temperature).

When the pre-heating temperature is 450° C. (value of (strain point−pre-heating temperature) is 128° C.), it is considered that calcium ions further deeply diffused in the glass, and it is also considered that glass structure is modified with diffusion of calcium ions in the glass, and the glass surface was roughened.

### Example 5

### Correlation Between Depth of Dented Defect and Pre-Heating Temperature

An aqueous solution containing Ca(NO₃)₂ (calcium concentration: 100 ppm) was allowed to drop onto a glass substrate in the same manner as in Example 3. The glass substrate was subjected to pre-heating (pre-heating temperature: 300, 330, 350 or 400° C.), subjected to ion exchange treatment at 450° C. for 7 hours, and then polished with a polishing cloth impregnated with abrasives (2 μm diameter diamond slurry) to remove foreign matters adhered to the glass surface.

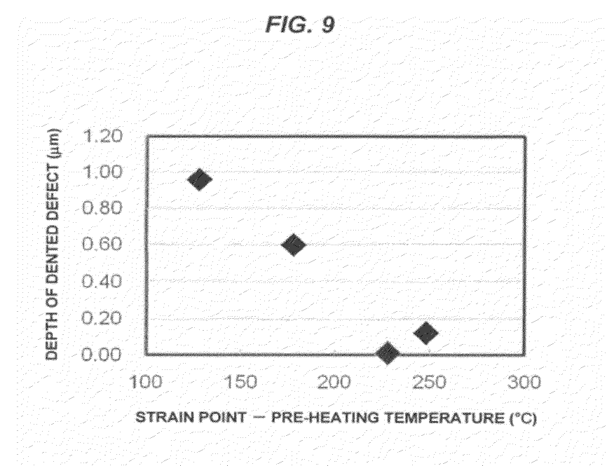

A depth of dented defect on the glass substrate was measured. The depth of the dented defect was measured in the same manner as in Example 1. A graph obtained by plotting the result in the form of pre-heating temperature vs. depth of dented defect is shown in FIG. 9.

As a result, it was apparent that the depth of dented defect is increased with increasing the pre-heating temperature as shown in FIG. 9. The fact that the depth of dented defect was increased has a correlation to the fact that the depth of the calcium ion diffusion layer was increased as shown in Example 4.

It was seen from the results in FIG. 9 that, although the depth of dented defect can be adjusted by the temperature of the chemical strengthening liquid in the ion exchange step and the time of the ion exchange step, the depth of dented defect can be adjusted to about 500 nm or less by controlling the value of (stain point−pre-heating temperature) to 178° C. or more.

It was further seen that when the value of (stain point−pre-heating temperature) is 220° C. or more, the depth of dented defect can be adjusted to ½ or less of the wavelength of the visible light and 200 nm or less that is considered to be the lower limit that ordinary observers can recognize as defects. Furthermore, it was seen that when the value of (stain point−pre-heating temperature) is about 278° C. (the lower limit of temperature capable of pre-heating), the depth of dented defect can be adjusted to 100 nm or less that cannot be recognized even by a skilled observer.

### Example 6

### Correlation Between Pre-Heating Temperature and Chemical Strengthening Liquid Temperature, and Depth of Dented Defect

An aqueous solution containing Ca(NO₃)₂ (calcium concentration: 100 ppm) was allowed to drop onto a glass substrate in the same manner as in Example 3. The glass substrate was subjected to pre-heating and ion exchange treatment under the conditions shown in Table 2, and then polished with a polishing cloth impregnated with abrasives (2 μm diameter diamond slurry) to remove foreign matters adhered to the glass surface.

A depth of dented defect on the glass substrate was measured. The depth of the dented defect was measured in the same manner as in Example 1. The results are shown in Table 2.

In Table 2, Examples 1, 2 and 5 are Working Examples, Examples 3, 4, 7 and 8 are Comparative Examples, and Example 6 is Reference Example. Only Example 8 used a glass having a strain point temperature 21° C. lower than that of other glasses.

TABLE 2

| | | Example 1 | Example 2 | Example 3 | Example 4 | Example 5 | Example 6 | Example 7 | Example 8 |
|---|---|---|---|---|---|---|---|---|---|
| Pre-heating temperature | (° C.) | 330 | 350 | 400 | 450 | 350 | 400 | 400 | 350 |
| Pre-heating time | (hour) | 4 | 4 | 4 | 4 | 4 | 4 | 4 | 4 |
| Chemical strengthening | (° C.) | 450 | 450 | 450 | 450 | 430 | 405 | 438 | 450 |
| liquid temperature | | | | | | | | | |
| Chemical strengthening | (hour) | 7 | 7 | 7 | 7 | 10 | 21.5 | 10 | 7 |
| time | | | | | | | | | |
| (Strain point - pre- | (° C.) | 248 | 228 | 178 | 128 | 228 | 178 | 178 | 207 |
| heating temperature) | | | | | | | | | |
| (Strain point - chemical | (° C.) | 128 | 128 | 128 | 128 | 148 | 173 | 140 | 107 |
| strengthening liquid | | | | | | | | | |
| temperature) | | | | | | | | | |
| (Chemical strengthening | (° C.) | 120 | 120 | 50 | 0 | 80 | 5 | 38 | 99 |
| liquid temperature - pre- | | | | | | | | | |
| heating temperature) | | | | | | | | | |
| Depth of dented defect | (μm) | 0.12 | 0.01 | 0.60 | 0.96 | 0.17 | 0.07 | 0.29 | 1.14 |
| Standard deviation of | | 0.08 | 0.01 | 0.20 | 0.29 | 0.05 | 0.10 | 0.10 | 0.35 |
| depth of dented defect | | | | | | | | | |

As shown in Table 2, in the Examples 1, 2 and 5 in which the value of (strain point−pre-heating temperature) was 220° C. or more, the depth of dented defect was 200 nm or less. On the other hand, in the Examples 3, 4, 7 and 8 in which the value of (strain point−pre-heating temperature) was less than 220° C., the depth of dented defect exceeded 200 nm. It was seen from the results that when the value of (strain point−pre-heating temperature) is 220° C. or more, the depth of dented defect can be adjusted to 200 nm or less.

It was seen from the comparison between Example 2 and Example 8 that when the value of (strain point−pre-heating temperature) is 220° C. or more and at the same time when the value of (strain point−chemical strengthening liquid temperature) is 120° C. or more, the depth of dented defect can further be decreased.

It was seen that, as shown in Example 6, in the case that the chemical strengthening treatment time is 12 hours or more, when the value of (strain point−chemical strengthening liquid temperature) is 150° C. or more, the depth of dented defect can effectively be decreased.

### REFERENCE EXAMPLE

### Analysis of Glass Composition on Surface of Dented Defects Occurred on Glass Surface by Dropping Solution Containing Calcium, Followed by Pre-Heating and Ion Exchange Treatment

10 ml of an aqueous solution containing 100 ppm of CaCl₂ was allowed to drop onto a glass substrate having the same glass composition as in Example 1. The glass substrate was dried at 90° C. for 60 minutes, subjected to pre-heating at 450° C. for 3 hours, and then subjected to ion exchange treatment at 450° C. for 7 hours using KNO₃ as a molten salt. Thus, a chemically strengthened glass was obtained.

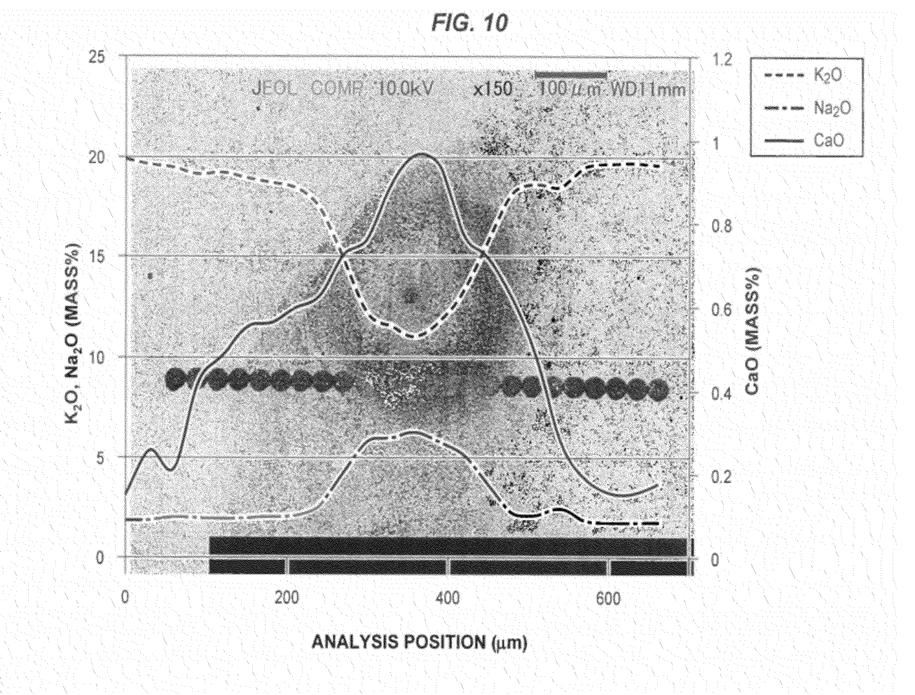

Dented defect occurred in the chemically strengthened glass obtained. Contents (unit: % by mass) of K₂O, Na₂O and CaO on the glass surface of the defect part and the part in the vicinity thereof were measured by energy dispersive X-ray spectroscopy. The results obtained are shown in FIG. 10.

Central hallow part in FIG. 10 is a dented defect part. Continuous dots to right and left at slightly lower central part in FIG. 10 are analysis traces.

In FIG. 10, a vertical axis (left) shows the contents (mass %) of K₂O andNa₂O in the glass composition, and a vertical axis (right) shows a content (mass %) of CaO in the glass composition. In FIG. 10, a horizontal axis shows an analysis position (μm) from the left end, and a length of a black scale at right-upper part is 100 μm.

As shown in FIG. 10, the contents of K₂O, Na₂O and CaO were from 18 to 20% by mass, 2% by mass and from 0.2 to 0.6% by mass at the part in the vicinity of the defect part, respectively, and were from 11 to 18% by mass, from 3 to 6% by mass and from 0.6 to 1% by mass at the defect part, respectively.

The results indicate that in the dented defect formed on the glass having been subjected to pre-heating and ion exchange treatment after contacting the glass with a solution containing calcium, calcium salt is formed, and ion exchange between sodium ions and potassium ions is inhibited.

Example 4 is an experiment conducted under the state of accelerating conditions, but Reference Example was conducted excluding those elements. As a result, it was seen that trace of Ca was found at the dented defect even after the ion exchange step, and diffusion of Ca as shown in FIG. 2 occurred even under the working conditions from which accelerating elements were eliminated.

While the invention has been described in detail and with reference to specific embodiments thereof, it will be apparent to one skilled in the art that various changes and modifications can be made therein without departing from the scope thereof.

This application is based on Japanese patent application No. 2011-065381 filed Mar. 24, 2011 and Japanese patent application No. 2012-007211 filed Jan. 17, 2012, the entire contents thereof being hereby incorporated by reference.

What is claimed is:

1. A process for producing a chemically strengthened glass substrate for a display device, the process comprising a pre-heating step of pre-heating a glass to a pre-heating temperature and subsequently an ion exchange step of immersing the glass in a chemical strengthening liquid,
wherein the pre-heating temperature in the pre-heating step and a strain point of the glass satisfy the following formula:
220° C.≦(strain point−pre-heating temperature).

2. The process for producing a chemically strengthened glass substrate for a display device according to claim 1, wherein the value of (strain point−pre-heating temperature) is 280° C. or less.

3. The process for producing a chemically strengthened glass substrate for a display device according to claim 1, wherein a chemical strengthening liquid temperature in the ion exchange step and the strain point of the glass satisfy the following formula:
120° C.≦(strain point−chemical strengthening liquid temperature).

4. The process for producing a chemically strengthened glass substrate for a display device according to claim 3, wherein the value of (strain point−chemical strengthening liquid temperature) is 170° C. or less.

5. The process for producing a chemically strengthened glass substrate for a display device according to claim 1, wherein the pre-heating temperature in the pre-heating step and a chemical strengthening liquid temperature in the ion exchange step satisfy the following formula:
55° C.≦(chemical strengthening liquid temperature−pre-heating temperature).

6. The process for producing a chemically strengthened glass substrate for a display device according to claim 3, wherein the pre-heating temperature in the pre-heating step and a chemical strengthening liquid temperature in the ion exchange step satisfy the following formula:
55° C.≦(chemical strengthening liquid temperature−pre-heating temperature).

7. The process for producing a chemically strengthened glass substrate for a display device according to claim 1, wherein a compressive stress layer formed on a surface of the chemically strengthened glass substrate has a surface compressive stress of 200 MPa or more.

8. The process for producing a chemically strengthened glass substrate for a display device according to claim 1, wherein a compressive stress layer formed on a surface of the chemically strengthened glass substrate has a thickness of 30 μm or more.

9. A process for producing a chemically strengthened glass substrate for a display device, the process comprising a pre-heating step of pre-heating a glass to a pre-heating temperature and subsequently an ion exchange step of immersing the glass in a chemical strengthening liquid,
wherein a chemical strengthening liquid temperature in the ion exchange step and a strain point of the glass satisfy the following formula:
150° C.≦(strain point−chemical strengthening liquid temperature), and
wherein a time for immersing the glass in the chemical strengthening liquid is 12 hours or more.

10. The process for producing a chemically strengthened glass substrate for a display device according to claim 9, wherein the pre-heating temperature in the pre-heating step and the strain point of the glass satisfy the following formula:
220° C.≦(strain point−pre-heating temperature).

11. The process for producing a chemically strengthened glass substrate for a display device according to claim 9, wherein the pre-heating temperature in the pre-heating step and the chemical strengthening liquid temperature in the ion exchange step satisfy the following formula:
55° C.≦(chemical strengthening liquid temperature−pre-heating temperature).

12. The process for producing a chemically strengthened glass substrate for a display device according to claim 9, wherein a compressive stress layer formed on a surface of the chemically strengthened glass substrate has a surface compressive stress of 200 MPa or more.

13. The process for producing a chemically strengthened glass substrate for a display device according to claim 9, wherein a compressive stress layer formed on a surface of the chemically strengthened glass substrate has a thickness of 30 μm or more.
